(19) United States
(12) Patent Application Publication
(10) Pub. No.: US 2015/0282010 A1
(43) Pub. Date: Oct. 1, 2015

(54) METHOD AND APPARATUS FOR SELECTING A CELL DURING CALL ORIGINATION

(71) Applicant: QUALCOMM Incorporated, San Diego, CA (US)

(72) Inventors: Ming YANG, San Diego, CA (US); Insung Kang, San Diego, CA (US); Qingxin Chen, Del Mar, CA (US); Tom Chin, San Diego, CA (US); Guangming Shi, San Diego, CA (US)

(73) Assignee: QUALCOMM Incorporated, San Diego, CA (US)

(21) Appl. No.: 14/242,530

(22) Filed: Apr. 1, 2014

(51) Int. Cl. H04W 36/00; H04W 68/00

(52) U.S. Cl. CPC H04W 36/0016; H04W 68/00; H04W 88/02

(57) ABSTRACT

Methods and apparatuses relating to wireless communication of a user equipment (UE) are provided including receiving an indication to perform a call origination procedure when communicating in a serving cell, selecting a neighbor cell for performing the call origination procedure based at least in part on receiving the indication and performing the call origination procedure with a wireless network using the neighbor cell after selecting the neighbor cell in response to receiving the indication. Selecting the neighbor cell can include performing reselection or switching subscriptions in a multiple subscription UE while delaying the call origination procedure until after the selection.

### BACKGROUND

Aspects of the present disclosure relate generally to wireless communication systems, and more particularly, to call origination by wireless devices.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). Another standard can include 3GPP long term evolution (LTE). The UMTS also supports enhanced 3G data communications protocols, such as High Speed Packet Access (HSPA), which provides higher data transfer speeds and capacity to associated UMTS networks.

User equipment (UE) can communicate with a cell in an active mode to perform voice or data communications, or in an idle mode such to camp on the cell to maintain minimal connectivity while awaiting a command to switch to active mode to initiate voice or data services with the cell. When in idle mode, the UE can reselect among one or more cells for camping as the UE moves throughout the network. Reselection to a neighbor cell is typically based on the UE determining that the neighbor cell provides improved connection (e.g., based on an improved signal strength), improved level of services, etc. for the UE over that of a current serving cell. When a UE detects a neighbor cell that meets some reselection criteria, the UE initiates a reselection timer (typically on the order of 2 seconds) after which the UE can perform the reselection to the neighbor cell if the neighbor cell still meets the reselection criteria. This can prevent the UE from ping-ponging or frequent reselection between cells where the neighbor cell only temporarily meets the reselection criteria due to intermittent interference.

It is possible that the UE, operating in idle mode, receives a call request or paging signal related to performing a call after detecting a neighbor cell for reselection but before expiration of the reselection timer. In this example, it is possible that the UE performs reselection to the neighbor cell following expiration of the reselection timer but before an access procedure to establish a channel for the call is completed. In this case, the network may continue to send access procedure communications to the UE via the serving cell though the UE is now camped on the neighbor cell. This increases downlink interference and consumes access channel resources at the serving cell, and also wastes the UE resources used in performing the access procedure attempt at the serving cell before reselecting to the neighbor cell. In addition, however, it may not be desirable to hold on the reselection and establish the channel with the serving cell, as signal strength or quality thereof may be degrading as the UE moves.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method of wireless communication of a user equipment (UE) is provided. The method includes receiving an indication to perform a call origination procedure when communicating in a serving cell, selecting a neighbor cell for performing the call origination procedure based at least in part on receiving the indication, and performing the call origination procedure with a wireless network using the neighbor cell after selecting the neighbor cell in response to receiving the indication.

In another aspect, an apparatus for wireless communication of a UE is provided. The apparatus includes means for receiving an indication to perform a call origination procedure when communicating in a serving cell, and means for selecting a neighbor cell for performing the call origination procedure based at least in part on receiving the indication, wherein the means for receiving is configured for performing the call origination procedure with a wireless network using the neighbor cell after the means for selecting selects the neighbor cell in response to receiving the indication.

According to a further aspect, an apparatus for wireless communication of a UE is provided including a call originating component operable for receiving an indication to perform a call origination procedure when communicating in a serving cell, and a selection component operable for selecting a neighbor cell for performing the call origination procedure based at least in part on receiving the indication, wherein the call originating component is further operable for performing the call origination procedure with a wireless network using the neighbor cell after the component selects the neighbor cell in response to receiving the indication.

In yet another aspect, a non-transitory computer-readable medium is provided that includes code executable by a computer for receiving an indication to perform a call origination procedure when communicating in a serving cell, code executable by the computer for selecting a neighbor cell for performing the call origination procedure based at least in part on receiving the indication, and code executable by the computer for performing the call origination procedure with a wireless network using the neighbor cell after selecting the neighbor cell in response to receiving the indication.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram illustrating an exemplary aspect of selecting cells for call origination in a wireless communication system;

FIG. 2 is a flow diagram illustrating an exemplary method for selecting cells for call origination in a wireless communication system;

FIG. 3 is a schematic diagram illustrating an exemplary aspect of switching subscriptions for call origination in a wireless communication system;

FIG. 4 is a flow diagram illustrating an exemplary method for switching subscriptions for call origination in a wireless communication system;

FIG. 5 is a schematic diagram illustrating an exemplary aspect of selecting cells for call origination in a wireless communication system;

FIG. 6 is a block diagram illustrating an example of a hardware implementation for an apparatus employing a processing system to perform the functions described herein;

FIG. 7 is a block diagram conceptually illustrating an example of a telecommunications system including a UE configured to perform the functions described herein;

FIG. 8 is a conceptual diagram illustrating an example of an access network for use with a UE configured to perform the functions described herein;

FIG. 9 is a conceptual diagram illustrating an example of a radio protocol architecture for the user and control planes for a base station and/or a UE configured to perform the functions described herein; and

FIG. 10 is a block diagram conceptually illustrating an example of a Node B in communication with a UE in a telecommunications system configured to perform the functions described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Described herein are various aspects related to performing cell selection during call origination to ensure reliable call setup. In an example, when call origination occurs at a user equipment (UE) after detecting a neighbor cell for selection but before the UE can typically select the neighbor cell, the UE can delay performing one or more steps of the call origination and can instead perform a selection operation to the neighbor cell. This can include performing reselection to the neighbor cell regardless of the reselection timer, switching subscriptions in a multiple subscription UE to communicate with the neighbor cell, etc. Following selection of the neighbor cell, the UE can continue performing the call origination. In an example, upon the UE receiving an indication of call origination, the UE can determine whether a signal strength or other measurement of the serving cell is below a first threshold and/or whether a signal strength or other measurement of the neighbor cell is above a second threshold. If so, the UE can delay the call origination while performing the cell selection, and can continue the call origination following reselection. In addition, in an example, the UE can determine a type of call related to the call origination, and can delay call origination to select the neighbor cell with improved signal strength, quality, etc. only for certain call types (e.g., emergency or voice calls over data calls).

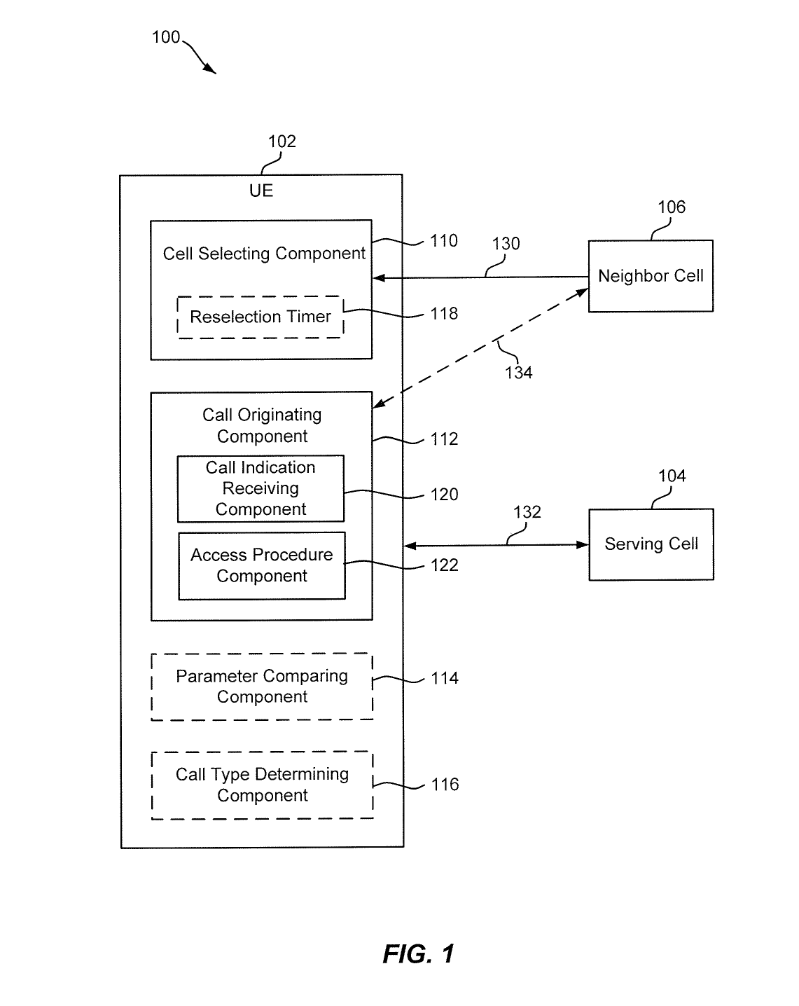

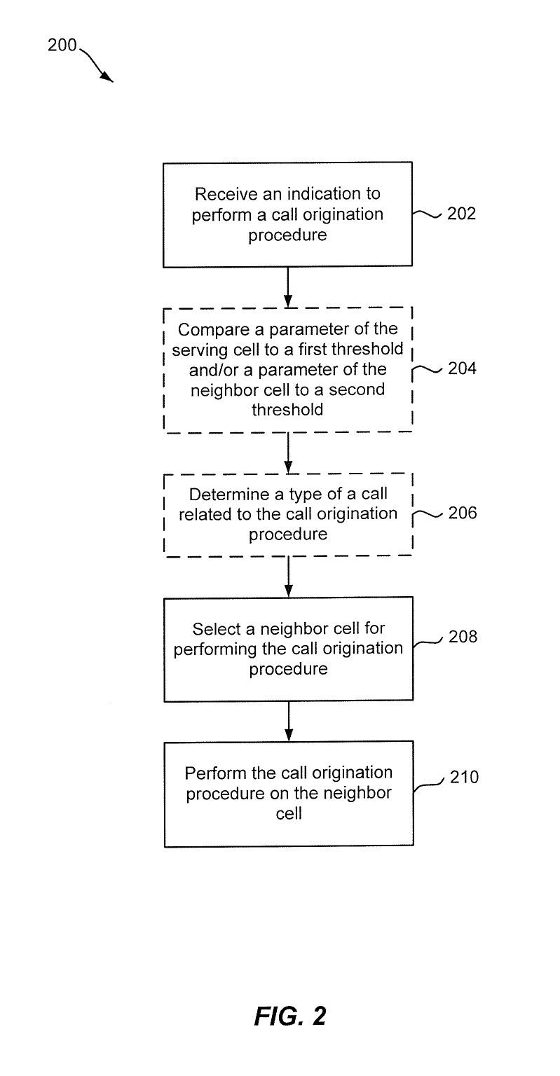

Referring to FIGS. 1 and 2, aspects of the present apparatus and method are depicted with reference to one or more components and one or more methods that may perform the actions or functions described herein. Although the operations described below in FIG. 2 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

In a particular aspect, a system 100 (FIG. 1) is illustrated for performing cell selection during call origination. System 100 includes a UE 102 that communicates with a serving cell 104 to access a wireless network (not shown). System 100 also includes a neighbor cell 106 to which the UE 102 can select or otherwise handover communications when the neighbor cell 106 meets certain criteria. It is to be appreciated that cells 104 and 106 can be provided by one or more access points, can operate over the same or different frequency spectrum, and/or can operate using the same or different radio access technologies (RAT). Thus, the UE 102 selecting from the serving cell 104 to the neighbor cell 106 can be an intra-frequency, inter-frequency, inter-RAT, etc. reselection, or can include switching subscriptions, as described further herein.

UE 102 can include a selection component, such as cell selecting component 110, for evaluating one or more cells for initiating or continuing a call origination procedure, such as by reselection, subscription switching, etc., a call originating component 112 for performing a call origination procedure with the wireless network while communicating in a cell, an optional parameter comparing component 114 for comparing one or more parameters with one or more thresholds to determine whether to perform selection of a neighbor cell, and/or an optional call type determining component 116 for determining whether to perform selection of the neighbor cell based on a type of call related to the call origination procedure. Cell selecting component 110 may optionally include a reselection timer 118 in the context of reselection for utilizing in determining when to perform a reselection. Moreover, for example, call originating component 112 can include a call indication receiving component 120 for obtaining an indication to perform a call origination procedure from the UE 102, from the wireless network (via one or more cells), and/or the like, and an access procedure component 122 for performing an access procedure to establish a dedicated channel in a cell for originating the call.

According to an example, UE 102 can communicate with the serving cell 104 in an idle mode to receive wireless network access (also referred to as camping), shown at 132. For example, idle mode communications can include the UE 102 utilizing a transceiver during periodic time intervals to allow the serving cell 104 to transmit to the UE 102 during the time intervals. Thus, for example, UE 102 may receive a paging signal or other communications from the serving cell 104 during one of the time intervals, which can provide information to the UE 102, cause the UE 102 to switch to an active mode and establish a channel with the serving cell 104, and/or the like.

In any case, when the UE 102 is communicating in idle mode, cell selecting component 110 can periodically evaluate neighboring cells, such as neighbor cell 106, in a reselection context, to determine whether to communicate with the neighbor cell 106 in idle mode (e.g., camp on the neighbor cell 106) instead of the serving cell 104. For example, cell selecting component 110 can initialize reselection timer 118 (e.g., periodically, upon expiration of the timer 118, based on detecting one or more parameters of a neighboring cell such as signal-to-noise ratio (SNR) over a threshold, based on detecting one or more parameters of serving cell 104 under a threshold, etc.). In this regard, cell selecting component 110 can evaluate cells for reselection while the reselection timer 118 has a non-zero value.

In determining whether to reselect to the neighbor cell 106, cell selecting component 110 can compare one or more parameters of the neighbor cell 106 to a threshold and/or to a similar parameter of serving cell 104. For example, cell selecting component 110 can compare a signal-to-noise ratio (SNR) or other measurement of the neighbor cell 106 to that of the serving cell 104, to a predetermined threshold, etc., and/or can compare a difference between the SNR or other measurement of the neighbor cell 106 and the serving cell 104 to a predetermined threshold. In this regard, for example, cell selecting component 110 can measure the strength or quality of a signal 130 received from neighbor cell 106 at UE 102. Where cell selecting component 110 determines the one or more measurements or differences in measurements achieve the predetermined threshold, cell selecting component 110 can determine that neighbor cell 106 is a candidate for reselection. If cell selecting component 110 considers neighbor cell 106 a candidate for reselection after expiration of the reselection timer 118, cell selecting component 110 can initiate reselection from the serving cell 104 to the neighbor cell 106. This can include requesting reselection from the serving cell 104 (e.g., shown at 132), where the serving cell 104 can then prepare the neighbor cell 106 for the reselection, and can send a command to the UE 102 to handover to neighbor cell 106.

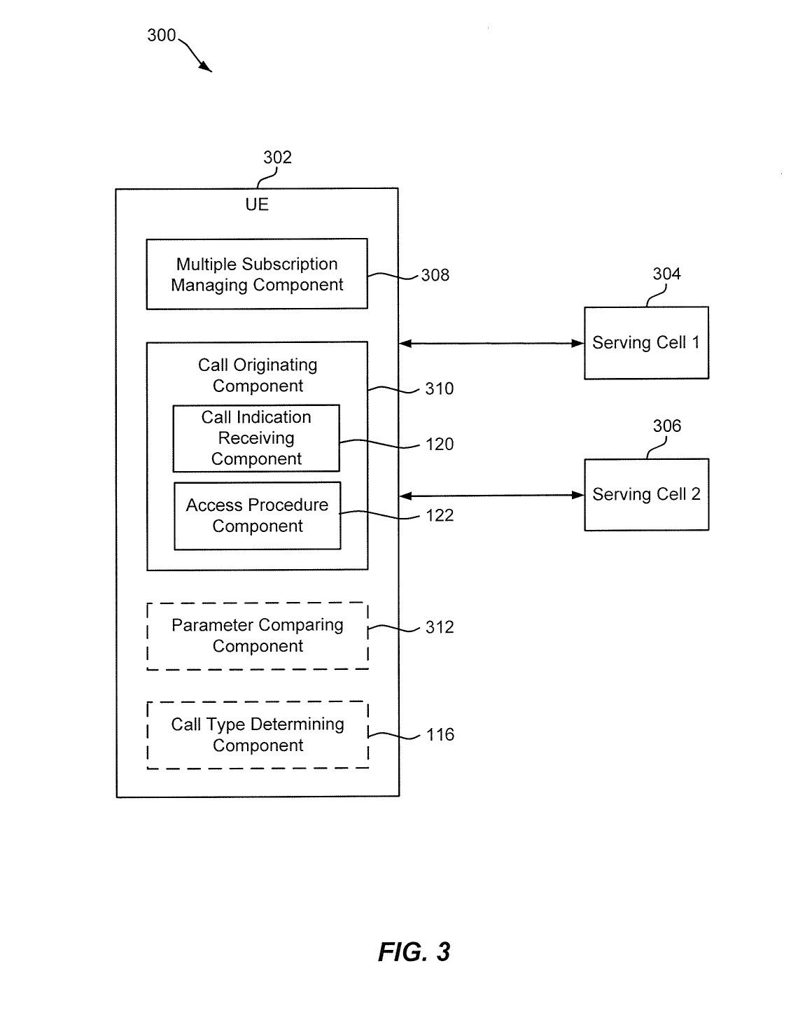

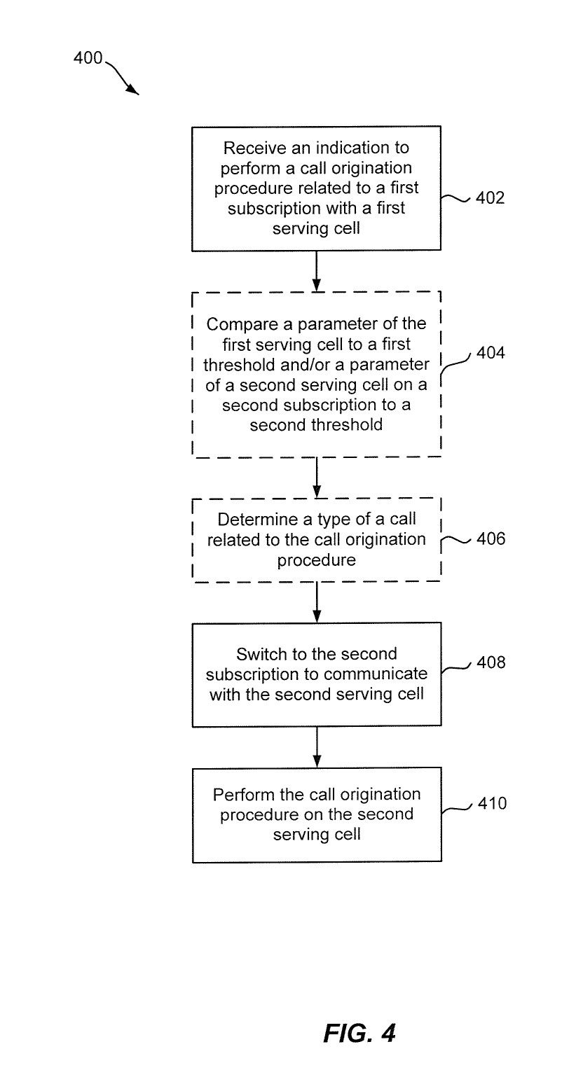

In a particular aspect, where the call originating component 112 receives an indication of a call origination procedure (e.g., in a call setup request from the UE 102, a paging signal received from the serving cell 104, etc.) before the reselection timer 118 expires, call originating component 112 can delay the call origination procedure while cell selecting component 110 reselects to the neighbor cell 106 under certain circumstances. This aspect will now be described in reference to FIGS. 1 and 2. In another example, in a multiple subscription UE 102, call originating component 112 can delay the call origination procedure while cell selecting component 110 switches subscriptions to communicate with the neighbor cell 106, which can be a serving cell of the subscription, under certain circumstances. This aspect is discussed in detail in reference to FIGS. 3 and 4.

A method 200 (FIG. 2) of wireless communication includes, at Block 202, receiving an indication to perform a call origination procedure. In an aspect, for instance, UE 102 may include call originating component 112 for receiving the indication and performing the call origination procedure. For example, call indication receiving component 120 can obtain the indication based at least in part on one of the UE 102 initiating a call and requesting the call origination procedure via a call setup request (e.g., received from an application layer of the UE 102), the UE 102 receiving a paging signal from the serving cell 104 during a paging interval to initiate the call origination procedure, as described, and/or the like. In any case, in response to receiving the call indication receiving component 120 receiving the indication, an access procedure component 122 may typically initiate an access procedure via serving cell 104 to switch to active mode in communicating with the serving cell in conventional configurations. This can include performing a forward access channel (FACH), random access channel (RACH), or other procedure involving sending a preamble over a common access channel, and awaiting receipt of parameters for establishing a dedicated channel with the serving cell for the active mode communications.

In an example, however, before the access procedure component 122 performs one or more steps of the access procedure, such as sending a preamble over a common access channel provided at the serving cell 104, method 200 can continue to Block 208 to select a neighbor cell for performing the call origination procedure. This can be performed using cell selecting component 110, as described above in a reselection context, to reselect to the neighbor cell 106, but can occur regardless of a value of the reselection timer 118 (e.g., cell selecting component 110 may reselect to the neighbor cell 106 even when the reselection timer 118 is running and has not expired). In another example, described further below, this can include cell selecting component 110 (or a multiple subscription managing component 308 (FIG. 3), as described below) selecting a second subscription that communicates with a second serving cell for performing the call origination procedure. In any case, it is to be appreciated that this selection may occur based on analyzing one or more additional parameters, examples of which are depicted in optional Blocks 204 and 206 of the method 200.

For instance, method 200 optionally includes, at Block 204, comparing a parameter of the serving cell to a first threshold and/or a parameter of the neighbor cell to a second threshold. In this regard, UE 102 may also optionally include a parameter comparing component 114 to compare the parameters to the thresholds, and call originating component 112 can determine whether to select the neighbor cell 106 before initiating or continuing the call origination procedure based on the comparisons. In one example, parameter comparing component 114 can compare a SNR or other cell strength or quality parameter of serving cell 104 to a predefined threshold, where the predefined threshold is set such that cell strength or quality that is less than the threshold is not reliable enough to receive communications from the serving cell 104 (e.g., a connection setup message as part of an access procedure). In another example, parameter comparing component 114 can additionally or alternatively compare a SNR or other cell strength or quality parameter of neighbor cell 106 to a predefined threshold, where this predefined threshold is set such that cell strength or quality at least at the threshold is reliable enough to receive communications from the neighbor cell 106 (e.g., to receive a connection setup message as part of the access procedure).

It is to be appreciated that these thresholds can be pre-configured in the UE 102 (e.g., based on a hardcoded configuration, a configuration received in an initialization procedure with the wireless network, etc.), and/or can be configured or modified based on other parameters, such as a receiver performance of the UE 102 within the network. For example, parameter comparing component 114 can determine a receiver performance at the UE 102 based on computing or obtaining one or more parameters related to receiving communications in a wireless network, such as an average data rate or throughput, an average observed SNR, a determined SNR based on a received signal strength indicated by a cell, and/or the like. In another example, parameter comparing component 114 can otherwise receive the receiver performance from one or more wireless network components. In any case, for example, parameter comparing component 114 can set one or more of the thresholds as a function of the UE receiver performance. For example, the serving cell strength or quality threshold and/or the neighbor cell strength or quality threshold can be set lower relative to a higher UE receiver performance, as higher UE receiver performance can indicate higher tolerance for lower network performance. Moreover, it is to be appreciated that the parameter comparing component 114, in an example, can tune the thresholds based on observed performance of the subsequent call origination procedures. For example, if a history of call origination during reselection or subscription switching occurring based on comparing the parameters to the first and/or second threshold fails to achieve a threshold success level when the neighbor cell is selected, parameter comparing component 114 can raise the thresholds to lessen the occurrence of selection. Likewise, if call origination fails to achieve a threshold success level on the serving cell when the neighbor cell is not selected, parameter comparing component 114 can lower the thresholds to increase the occurrence of selection.

In another example, method 200 optionally includes, at Block 206, determining a type of a call related to the call origination procedure. In this regard, UE 102 may also optionally include a call type determining component 116 for detecting a type of a call related to the call origination procedure, and call originating component 112 can determine whether to select the neighbor cell 106 for initiating or continuing a call origination procedure based at least in part on the call type. In this example, call type determining component 116 determines the call type based at least in part on information included in the indication received at call indication receiving component 120, such as a type indicator in the indication (e.g., a voice or data indicator), a RAT or other resources to which the indication relates (e.g., a voice or data RAT or other resources), an access channel type over which to perform the access procedure, an emergency or other urgency indicator that may be specified in the indication (e.g., to indicate a 911 or other emergency call), and/or the like. In an example, where the type of the call is voice or an otherwise urgent call, call originating component 112 can determine to select the neighbor cell for initiating or continuing the call origination procedure.

In other examples, call originating component 112 can determine to compare the parameters to the thresholds based on the detected call type (and thus Blocks 204 and 206 can be reversed in method 200). In this example, it is to be appreciated that the optimization described herein may not be performed for certain types of calls (e.g., data calls). In yet another example, parameter comparing component 114 can compare the parameters to thresholds, where the thresholds can be configured or can have different values for different call type (e.g., the cell strength or quality thresholds for the serving and/or neighbor cells may be lower for voice calls than for data calls).

In the above examples, call originating component 112 delays the call origination procedure until after UE 102 has selected the neighbor cell 106. In a reselection context, where cell selecting component 110 reselects the neighbor cell 106, this allows for avoiding the case where: the UE 102 starts the call origination procedure; does not complete the procedure before the reselection timer 118 expires; and reselects the neighbor cell 106 according to the conventional reselection procedure. This can also conserve signaling resources in the network as well as prevent the UE 102 from wasting a portion of the call origination procedure that the UE 102 can perform after reselection to the neighbor cell 106. In addition, in an example, it is to be appreciated that, in the context of reselection, the cell selecting component 110 can reset the reselection timer 118 after reselecting the neighbor cell 106.

In any case, once the neighbor cell is selected for performing the call origination procedure, the method 200 includes, at Block 210, performing the call origination procedure on the neighbor cell. In this example, the access procedure component 122 can initiate, or otherwise continue, an access procedure while camped on the neighbor cell 106. As described, this can include transmitting an access preamble on a common access channel at the neighbor cell 106 (e.g., a RACH, FACH, or similar channel). A response can be received from the neighbor cell 106, which may include instructions or other parameters for establishing a dedicated traffic channel at the neighbor cell 106, based on which the access procedure component 122 can establish the dedicated traffic channel at neighbor cell 106, which can be shown in FIG. 1 at 134. Call originating component 112 can then communicate with the neighbor cell 106 in an active mode and can initiate the call relating to the call origination procedure over the dedicated channel. It is to be appreciated that call originating component 112 may determine not to select neighbor cell 106 based on the parameters not achieving thresholds, based on certain call types, etc., in which case call originating component 112 can establish active mode communications with the serving cell 104, and perform the call origination procedure therewith.

Though described in terms of general selection or idle mode reselection where the UE 102 terminates communication with the serving cell 104 in favor of camping on the neighbor cell 106, it is to be appreciated that the functions described herein may apply to other configurations as well. For example, FIGS. 3 and 4 depict aspects described herein as utilized in a UE with a multiple subscription configuration. Although the operations described below in FIG. 4 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

In a particular aspect, a system 300 (FIG. 3) is illustrated for operating using multiple subscriptions. System 300 includes a UE 302 that communicates with a serving cell 1 304 to access a wireless network (not shown) and a serving cell 2 306 to access another wireless network (not shown). In some cases, serving cell 2 306 may access the same wireless network as the one accessed with serving cell 1 304 using a different cell, different resources, a different RAT, etc. It is to be appreciated that the UE 302 can access the serving cells 304 and 306 using different subscriptions in the different wireless networks (which can include using different subscriber identity modules (SIM), and/or the like). It is to be appreciated that cells 304 and 306 can be provided by one or more access points, can operate over the same or different frequency spectrum, and/or can operate using the same or different RAT to access a same or different wireless network, etc.

UE 302 can include a selection component, such as a multiple subscription managing component 308, for facilitating communications over multiple subscriptions to multiple wireless networks (e.g., via cells 304 and 306 and/or additional cells). It is to be appreciated that multiple subscription managing component 308 can be a type of cell selecting component 110. UE 302 can also include a call originating component 310 for performing a call origination procedure with one or more of the multiple wireless networks, an optional parameter comparing component 312 for comparing one or more parameters of multiple serving cells with one or more thresholds to determine whether to switch subscriptions for performing the call origination procedure, and/or an optional call type determining component 116 for determining whether to switch subscriptions for performing the call origination procedure based on a type of call related to the call origination procedure. Moreover, for example, call originating component 310 can include a call indication receiving component 120 for obtaining an indication to perform a call origination procedure from the UE 102, from the wireless network (via one or more cells 304 or 306), and/or the like, and an access procedure component 122 for performing an access procedure to establish a channel for originating the call.

According to an example, method 400 (FIG. 4) includes, at Block 402, receiving an indication to perform a call origination procedure related to a first subscription with a first serving cell. As described, call originating component 310 can receive the indication from a serving cell, such as serving cell 1 304 using the first subscription. For example, call indication receiving component 120 can obtain the indication based at least in part on one of the UE 302 initiating a call and requesting the call origination procedure, the UE 302 receiving a paging signal from the serving cell 1 304 to initiate the call origination procedure, and/or the like. Moreover, as described, normally UE 302 may perform the call origination procedure, but in some circumstances, call originating component 310 may determine to use multiple subscription managing component 308 to switch to the second subscription before performing the call origination procedure.

Method 400 thus includes, at Block 408, switching to the second subscription to communicate with the serving cell after receiving the indication to perform the call origination procedure at 402. Call originating component 310 may determine to switch subscriptions in this regard based on comparing parameters of serving cells 304 and 306, determining a call type, etc. as described.

In one example, method 400 optionally includes, at Block 404, comparing a parameter of the first serving cell to a first threshold and/or a parameter of a second serving cell on a second subscription to a second threshold. UE 302 can include an optional parameter comparing component 312 for this purpose. For example, parameter comparing component 312 can compare a signal strength or quality parameter of serving cell 1 304 (e.g., a SNR) to a first threshold and/or a similar signal strength or quality parameter of serving cell 2 306 to a second threshold. In another example, parameter comparing component 312 can compare a difference between the parameters to a threshold. If one or more of the parameters (or a difference of parameters) achieve the threshold, as described previously, call originating component 310 can determine use multiple subscription managing component 308 to switch to the second subscription to perform the call origination procedure with serving cell 2 306 instead of serving cell 1 304. The thresholds can be predetermined and/or configured in UE 302 as described previously, for example.

Moreover, in another example, method 400 optionally includes, at Block 406, determining a type of a call related to the call origination procedure. UE 302 can optionally include a call type determining component 116, as described above, for this purpose. Also, as described, call originating component 310 can determine whether to switch subscriptions for performing the call origination procedure based on the call type. In addition, for example, the thresholds for comparing at Block 404 can be set differently for different call types, as described, such that subscription switching occurs for voice or emergency calls over data calls, etc., in an example.

In any case, once it is determined to switch subscriptions before performing the call origination procedure, the method 400 includes, at Block 408, switching to the second subscription to communicate with the second serving cell. In this example, call originating component 310 can cause multiple subscription managing component 308 to switch to the second subscription with serving cell 2 306 for communications. Call originating component 310 delays the call origination procedure until after multiple subscription managing component 308 has switched subscriptions. It is to be appreciated, however, that switching subscriptions may not involve a setup procedure, and the multiple subscription managing component 308 can begin the access procedure using the second subscription.

Following switching the subscriptions, the method 400 includes, at Block 410, performing the call origination procedure on the second serving cell using the second subscription. In this example, the access procedure component 122 can initiate, or otherwise continue, an access procedure while camped on the serving cell 2 306 via the second subscription. As described, this can include transmitting an access preamble on a common access channel at the serving cell 2 306 (e.g., a RACH, FACH, or similar channel). A response can be received from the serving cell 2 306, which may include instructions or other parameters for establishing a dedicated traffic channel at the serving cell 2 306, based on which the access procedure component 122 can establish the dedicated traffic channel at serving cell 2 306. Thus, call originating component 310 can communicate in an active mode with serving cell 2 306 to initiate the call relating to the call origination procedure over the dedicated channel.

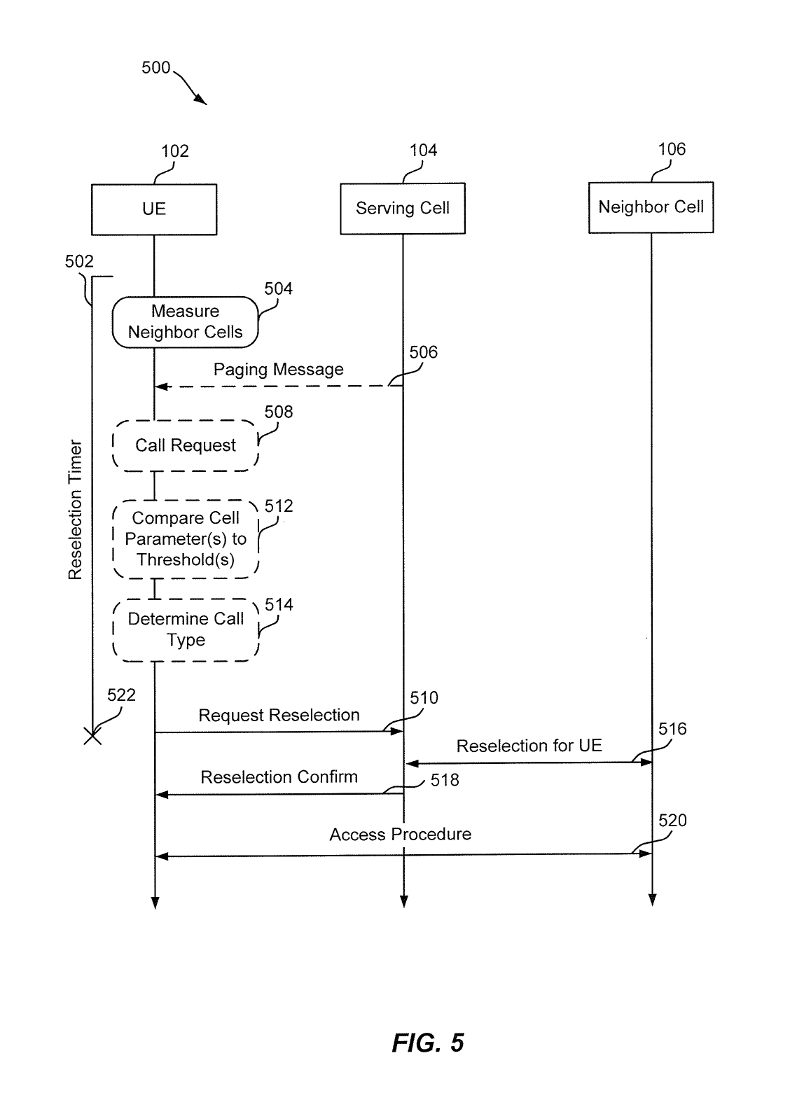

FIG. 5 illustrates an example system 500 for performing cell reselection based at least in part on an indication of a call origination procedure. System 500 includes a UE 102 that communicates with a serving cell 104 to receive wireless network access, and a neighbor cell 106 to which the UE 102 can reselect, as described above. UE 102 can initiate a reselection timer as shown at 502, during which the UE 102 can measure one or more neighbor cells at 504 for reselection, such as neighbor cell 106. In conventional systems, the UE 102 would wait for the expiration of reselection timer 502 before reselecting to neighbor cell 106 or other cells. As described, however, this can result in the UE 102 performing a call origination procedure while the reselection timer 502 is running and has not expired. Thus, where UE 102 receives a paging message 506 from serving cell 104, or detects a call request 508 at the UE 102 (e.g., to perform an access procedure for establishing a call over a dedicated traffic channel with serving cell 104), UE 102 can delay continuing performance of the call origination procedure (e.g., the access procedure) and can instead perform reselection to a neighbor cell 106 by requesting reselection from the serving cell 104 at 510 in an attempt to establish a more reliable call channel with neighbor cell 106.

As described, UE 102 can optionally compare one or more cell parameters to one or more thresholds at 512 to determine whether to request reselection at 510. In an example, UE 102 can compare a signal strength or quality of serving cell 104 to a first threshold and/or a signal strength or quality of neighbor cell 106 to a second threshold. Where the strength or quality of serving cell 104 is less than the first threshold, and the signal strength or quality of neighbor cell 106 achieves (or exceeds) the second threshold (or a difference between the two parameters achieves (or exceeds) a threshold), UE 102 can determine to request reselection at 510. Otherwise, UE 102 can continue to communicate with serving cell 104 and can establish active mode therewith to perform the call origination procedure. In addition or alternatively, UE 102 can determine a call type at 514 and can request reselection 510 based on the call type (e.g., request reselection for voice calls and not data calls). Moreover, in an example, UE 102 can determine the thresholds to use at 512 based on the call type 514, as described. Thus, these steps 512 and 514 can occur in opposite order as that depicted in FIG. 5.

After reselection is requested at 510, serving cell 104 can process the reselection at least in part by communicating reselection for the UE with neighbor cell 106 at 516. This can include communicating UE 102 parameters to neighbor cell 106 to allow for a seamless reselection for the UE 102, such as a UE 102 identifier, radio bearer information, and/or the like. Once neighbor cell 106 has been prepared for the reselection, in this example, serving cell 104 can confirm reselection to the UE 102 at 518. It is to be appreciated, in an example, that UE 102 may perform reselection with or without the backend preparation of neighbor cell 106 as described herein. In any case, UE 102 can be camped on neighbor cell 106, and can perform an access procedure 520 with the neighbor cell 106 to establish active mode communications as part of performing a call origination procedure for the paging message 506 or call request 508. This can provide a more reliable call as the neighbor cell 106 can be determined to have improved signal strength or quality over that of serving cell 104 at 512. In addition, it is to be appreciated that UE 102 can terminate the reselection timer at 522, which can be at the point of requesting reselection 510 or a period of time thereafter (such as upon receiving the reselection confirm at 518, and/or the like).

In another example, as described above, UE 102 can operate using multiple subscriptions and can communicate with serving cell 104 using a first subscription and neighbor cell 106 using a second subscription (for which neighbor cell 106 is a serving cell). In this example, the cell parameters compared at 512 can include comparing the serving cell 104 of the first subscription to the serving cell (neighbor cell 106) of the second subscription. For example, where the signal strength or quality of the serving cell 104 of the first subscription is below the first threshold and/or the signal strength or quality of the serving cell of the second subscription (neighboring cell 106) achieves a second threshold (or a difference between the two parameters achieves a threshold), UE 102 can determine to switch subscriptions (instead of performing reselection steps 510, 516, and 518) and can perform the access procedure 520 with the second serving cell (neighbor cell 106) over the second subscription.

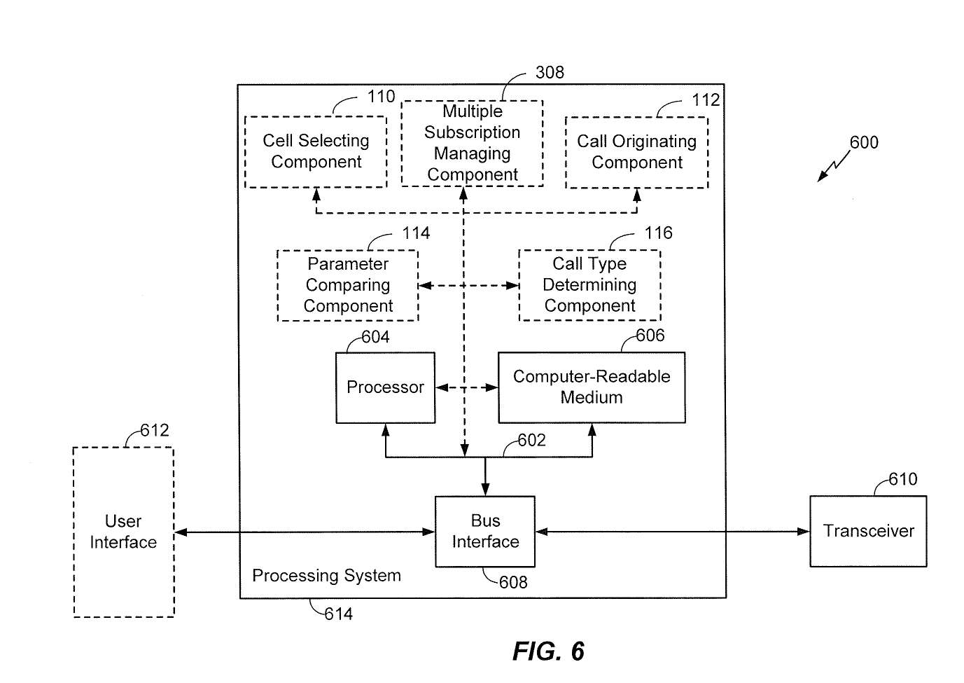

FIG. 6 is a block diagram illustrating an example of a hardware implementation for an apparatus 600 employing a processing system 614. Apparatus 600 may be configured to include, for example, UE 102 or 302 (FIGS. 1 and 3), and one or more of cell selecting component 110, call originating component 112 (or 310), parameter comparing component 114 (or 312), call type determining component 116, multiple subscription managing component 308, etc., as described above. In this example, the processing system 614 may be implemented with a bus architecture, represented generally by the bus 602. The bus 602 may include any number of interconnecting buses and bridges depending on the specific application of the processing system 614 and the overall design constraints. The bus 602 links together various circuits including one or more processors, represented generally by the processor 604, and computer-readable media, represented generally by the computer-readable medium 606. The bus 602 may also link various other circuits such as timing sources, peripherals, voltage regulators, and power management circuits, which are well known in the art, and therefore, will not be described any further. A bus interface 608 provides an interface between the bus 602 and a transceiver 610. The transceiver 610 provides a means for communicating with various other apparatus over a transmission medium. Depending upon the nature of the apparatus, a user interface 612 (e.g., keypad, display, speaker, microphone, joystick) may also be provided.

The processor 604 is responsible for managing the bus 602 and general processing, including the execution of software stored on the computer-readable medium 606. The software, when executed by the processor 604, causes the processing system 614 to perform the various functions described infra for any particular apparatus. The computer-readable medium 606 may also be used for storing data that is manipulated by the processor 604 when executing software.

In an aspect, processor 604, computer-readable medium 606, or a combination of both may be configured or otherwise specially programmed to perform the functionality of the cell selecting component 110, call originating component 112 (or 310), parameter comparing component 114 (or 312), call type determining component 116, multiple subscription managing component 308, or various other components described herein.

The various concepts presented throughout this disclosure may be implemented across a broad variety of telecommunication systems, network architectures, and communication standards.

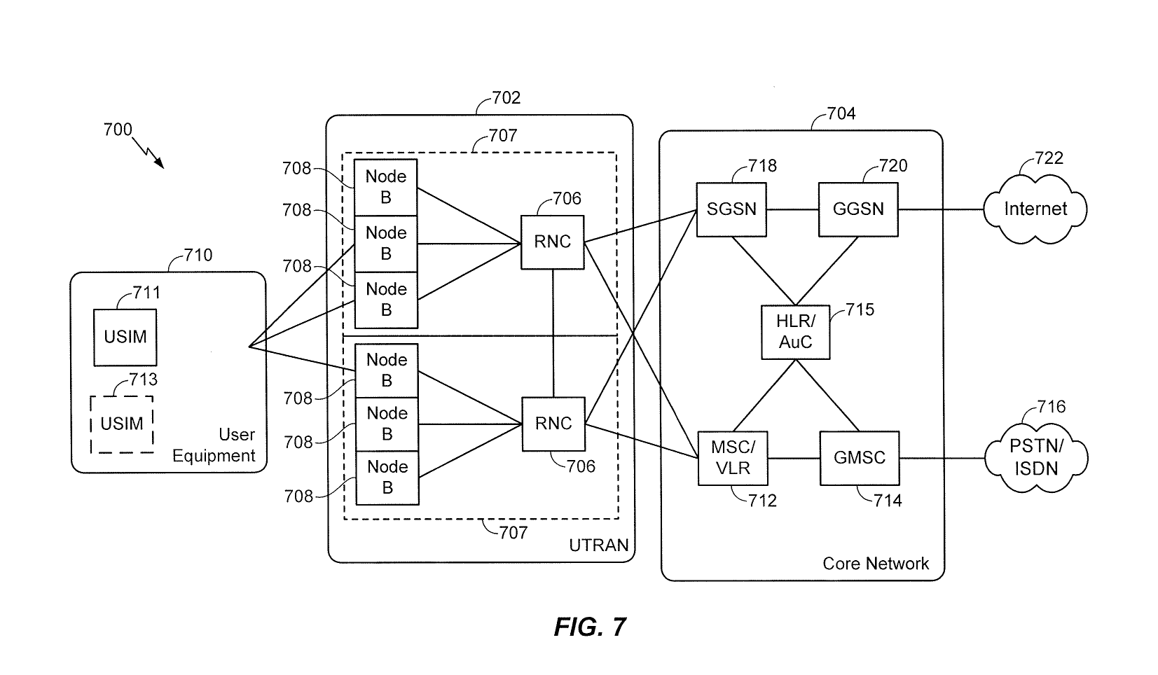

Referring to FIG. 7, by way of example and without limitation, the aspects of the present disclosure are presented with reference to a UMTS system 700 employing a W-CDMA air interface. A UMTS network includes three interacting domains: a Core Network (CN) 704, a UMTS Terrestrial Radio Access Network (UTRAN) 702, and User Equipment (UE) 710. UE 710 may be similar to UE 102 or 302 and configured to include, for example, one or more of the cell selecting component 110, call originating component 112 (or 310), parameter comparing component 114 (or 312), call type determining component 116, multiple subscription managing component 308, etc., as described above. In this example, the UTRAN 702 provides various wireless services including telephony, video, data, messaging, broadcasts, and/or other services. The UTRAN 702 may include a plurality of Radio Network Subsystems (RNSs) such as an RNS 707, each controlled by a respective Radio Network Controller (RNC) such as an RNC 706. Here, the UTRAN 702 may include any number of RNCs 706 and RNSs 707 in addition to the RNCs 706 and RNSs 707 illustrated herein. The RNC 706 is an apparatus responsible for, among other things, assigning, reconfiguring and releasing radio resources within the RNS 707. The RNC 706 may be interconnected to other RNCs (not shown) in the UTRAN 702 through various types of interfaces such as a direct physical connection, a virtual network, or the like, using any suitable transport network.

Communication between a UE 710 and a Node B 708 may be considered as including a physical (PHY) layer and a medium access control (MAC) layer. Further, communication between a UE 710 and an RNC 706 by way of a respective Node B 708 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331, incorporated herein by reference.

The geographic region covered by the RNS 707 may be divided into a number of cells, such as including serving cells 104, 304, 306, neighbor cell 106, etc., with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 708 are shown in each RNS 707; however, the RNSs 707 may include any number of wireless Node Bs. The Node Bs 708 provide wireless access points to a CN 704 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The UE 710 is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 710 may further include a universal subscriber identity module (US1M) 711, which contains a user's subscription information to a network. Moreover, in some examples described herein, the UE 710 can be a multiple subscription UE that includes another USIM 713 including subscription information for another network with which the UE 710 can communicate. For illustrative purposes, one UE 710 is shown in communication with a number of the Node Bs 708. The DL, also called the forward link, refers to the communication link from a Node B 708 to a UE 710, and the UL, also called the reverse link, refers to the communication link from a UE 710 to a Node B 708.

The CN 704 interfaces with one or more access networks, such as the UTRAN 702. As shown, the CN 704 is a GSM core network. However, as those skilled in the art will recognize, the various concepts presented throughout this disclosure may be implemented in a RAN, or other suitable access network, to provide UEs with access to types of CNs other than GSM networks.

The CN 704 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 704 supports circuit-switched services with a MSC 712 and a GMSC 714. In some applications, the GMSC 714 may be referred to as a media gateway (MGW). One or more RNCs, such as the RNC 706, may be connected to the MSC 712. The MSC 712 is an apparatus that controls call setup, call routing, and UE mobility functions. The MSC 712 also includes a VLR that contains subscriber-related information for the duration that a UE is in the coverage area of the MSC 712. The GMSC 714 provides a gateway through the MSC 712 for the UE to access a circuit-switched network 716. The GMSC 714 includes a home location register (HLR) 715 containing subscriber data, such as the data reflecting the details of the services to which a particular user has subscribed. The HLR is also associated with an authentication center (AuC) that contains subscriber-specific authentication data. When a call is received for a particular UE, the GMSC 714 queries the HLR 715 to determine the UE's location and forwards the call to the particular MSC serving that location.

The CN 704 also supports packet-data services with a serving GPRS support node (SGSN) 718 and a gateway GPRS support node (GGSN) 720. GPRS, which stands for General Packet Radio Service, is designed to provide packet-data services at speeds higher than those available with standard circuit-switched data services. The GGSN 720 provides a connection for the UTRAN 702 to a packet-based network 722. The packet-based network 722 may be the Internet, a private data network, or some other suitable packet-based network. The primary function of the GGSN 720 is to provide the UEs 710 with packet-based network connectivity. Data packets may be transferred between the GGSN 720 and the UEs 710 through the SGSN 718, which performs primarily the same functions in the packet-based domain as the MSC 712 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 708 and a UE 710. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels:the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 710 provides feedback to the node B 708 over the HS-DPCCH to indicate whether it correctly decoded a packet on the downlink.

HS-DPCCH further includes feedback signaling from the UE 710 to assist the node B 708 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 708 and/or the UE 710 may have multiple antennas supporting MIMO technology. The use of MIMO technology enables the node B 708 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 710 to increase the data rate, or to multiple UEs 710 to increase the overall system capacity. This is achieved by spatially precoding each data stream and then transmitting each spatially precoded stream through a different transmit antenna on the downlink. The spatially precoded data streams arrive at the UE(s) 710 with different spatial signatures, which enables each of the UE(s) 710 to recover the one or more the data streams destined for that UE 710. On the uplink, each UE 710 may transmit one or more spatially precoded data streams, which enables the node B 708 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

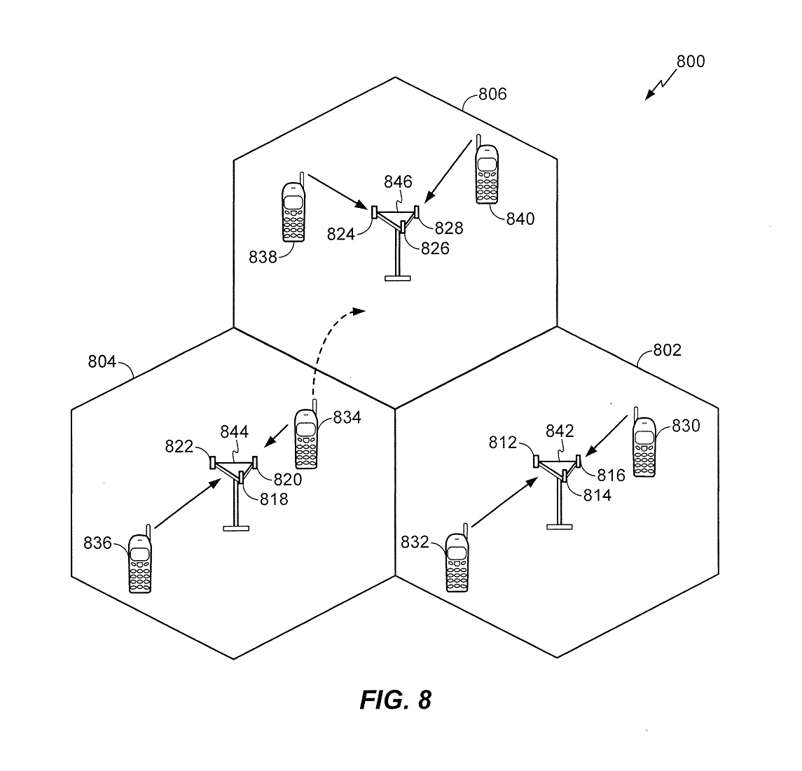

Referring to FIG. 8, an access network 800 in a UTRAN architecture is illustrated. The multiple access wireless communication system includes multiple cellular regions (cells), including cells 802, 804, and 806, each of which may include one or more sectors. The multiple sectors can be formed by groups of antennas with each antenna responsible for communication with UEs in a portion of the cell. For example, in cell 802, antenna groups 812, 814, and 816 may each correspond to a different sector. In cell 804, antenna groups 818, 820, and 822 each correspond to a different sector. In cell 806, antenna groups 824, 826, and 828 each correspond to a different sector. The cells 802, 804 and 806 may include several wireless communication devices, e.g., User Equipment or UEs, which may be in communication with one or more sectors of each cell 802, 804 or 806. For example, UEs 830 and 832 may be in communication with Node B 842, UEs 834 and 836 may be in communication with Node B 844, and UEs 838 and 840 can be in communication with Node B 846. Here, each Node B 842, 844, 846 is configured to provide an access point to a CN 704 (see FIG. 7) for all the UEs 830, 832, 834, 836, 838, 840 in the respective cells 802, 804, and 806. UEs 830, 832, 834, 836, 838, and 840 may be similar to UEs 102 or 302, described above, and Node Bs 842, 844, and/or 846 can provide one or more of serving cells 104, 304, 306, and/or neighbor cell 106.

As the UE 834 moves from the illustrated location in cell 804 into cell 806, a serving cell change (SCC) or handover may occur in which communication with the UE 834 transitions from the cell 804, which may be referred to as the source cell, to cell 806, which may be referred to as the target cell. Management of the handover procedure may take place at the UE 834, at the Node Bs corresponding to the respective cells, at a radio network controller 706 (see FIG. 7), or at another suitable node in the wireless network. For example, during a call with the source cell 804, or at any other time, the UE 834 may monitor various parameters of the source cell 804 as well as various parameters of neighboring cells such as cells 806 and 802. Further, depending on the quality of these parameters, the UE 834 may maintain communication with one or more of the neighboring cells. During this time, the UE 834 may maintain an Active Set, that is, a list of cells that the UE 834 is simultaneously connected to (i.e., the UTRA cells that are currently assigning a downlink dedicated physical channel DPCH or fractional downlink dedicated physical channel F-DPCH to the UE 834 may constitute the Active Set).

The modulation and multiple access scheme employed by the access network 800 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

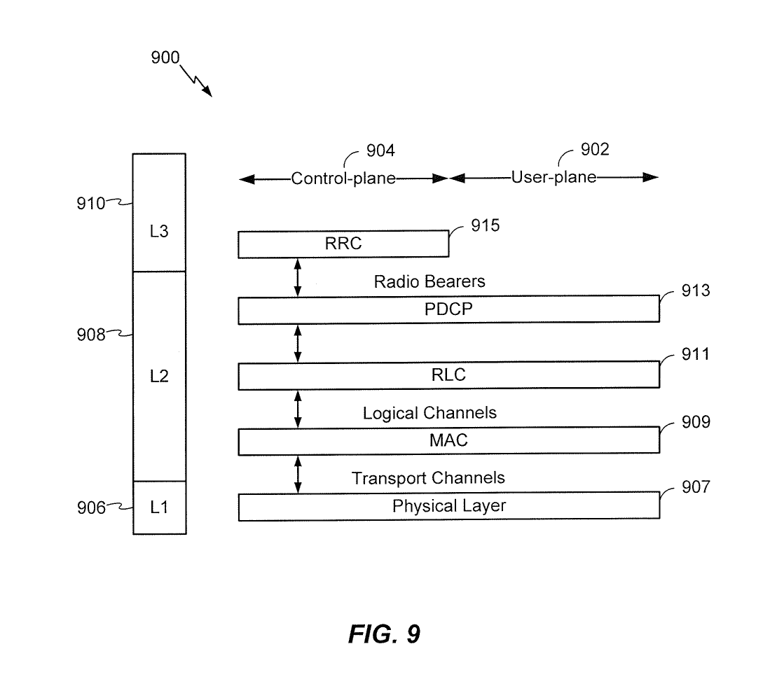

The radio protocol architecture may take on various forms depending on the particular application. An example for an HSPA system will now be presented with reference to FIG. 9.

FIG. 9 is a conceptual diagram illustrating an example of the radio protocol architecture 900 for the user plane 902 and the control plane 904 of a user equipment (UE) or node B/base station. For example, architecture 900 may be included in a network entity and/or UE such as an entity within UE 102 or 302, a Node B or other device providing serving cells 104 or 304, neighbor cell 106, serving cell 306 (FIGS. 1 and 3), etc. The radio protocol architecture 900 for the UE and node B is shown with three layers: Layer 1 906, Layer 2 908, and Layer 3 910. Layer 1 906 is the lowest lower and implements various physical layer signal processing functions. As such, Layer 1 906 includes the physical layer 907. Layer 2 (L2 layer) 908 is above the physical layer 907 and is responsible for the link between the UE and node B over the physical layer 907. Layer 3 (L3 layer) 910 includes a radio resource control (RRC) sublayer 915. The RRC sublayer 915 handles the control plane signaling of Layer 3 between the UE and the UTRAN.

In the user plane, the L2 layer 908 includes a media access control (MAC) sublayer 909, a radio link control (RLC) sublayer 911, and a packet data convergence protocol (PDCP) 913 sublayer, which are terminated at the node B on the network side. Although not shown, the UE may have several upper layers above the L2 layer 908 including a network layer (e.g., IP layer) that is terminated at a PDN gateway on the network side, and an application layer that is terminated at the other end of the connection (e.g., far end UE, server, etc.).

The PDCP sublayer 913 provides multiplexing between different radio bearers and logical channels. The PDCP sublayer 913 also provides header compression for upper layer data packets to reduce radio transmission overhead, security by ciphering the data packets, and handover support for UEs between node Bs. The RLC sublayer 911 provides segmentation and reassembly of upper layer data packets, retransmission of lost data packets, and reordering of data packets to compensate for out-of-order reception due to hybrid automatic repeat request (HARQ). The MAC sublayer 909 provides multiplexing between logical and transport channels. The MAC sublayer 909 is also responsible for allocating the various radio resources (e.g., resource blocks) in one cell among the UEs. The MAC sublayer 909 is also responsible for HARQ operations.

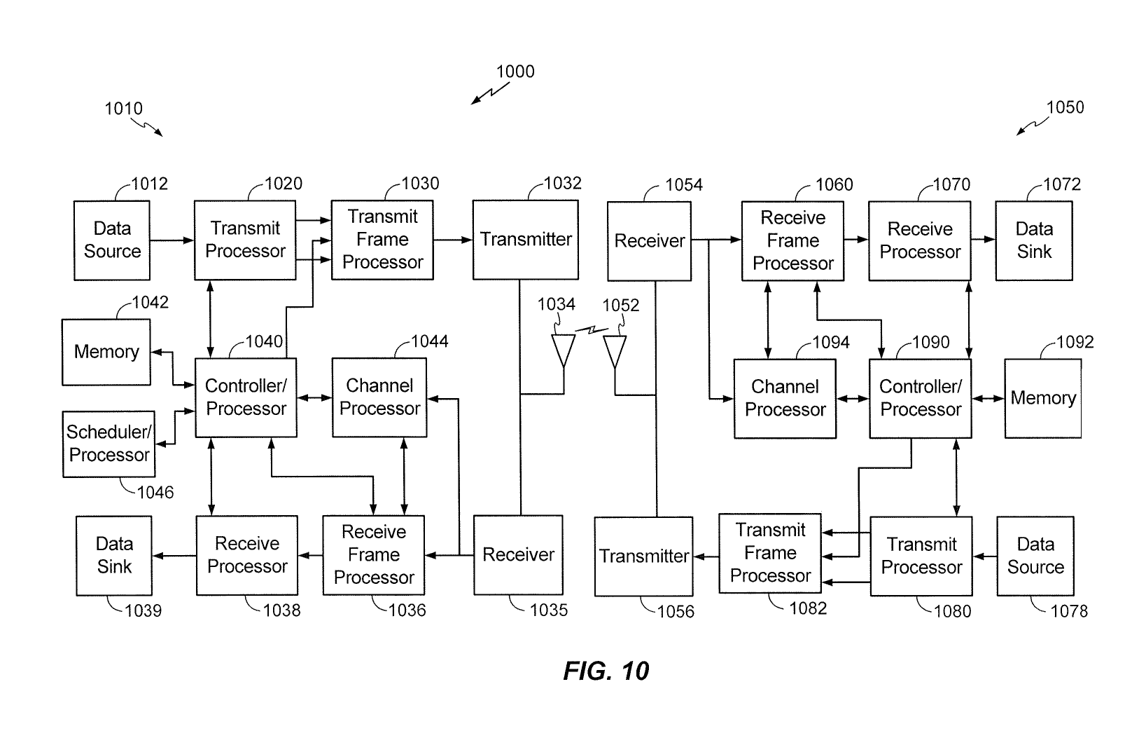

FIG. 10 is a block diagram of a communication system 1000 including a Node B 1010 in communication with a UE 1050, where Node B 1010 may include a node that provides serving cells 104, 304, or 306, neighbor cell 106, etc., and the UE 1050 may be UE 102 or 302, etc., including one or more of the cell selecting component 110, call originating component 112 (or 310), parameter comparing component 114 (or 312), call type determining component 116, multiple subscription managing component 308, etc. In the downlink communication, a transmit processor 1020 may receive data from a data source 1012 and control signals from a controller/processor 1040. The transmit processor 1020 provides various signal processing functions for the data and control signals, as well as reference signals (e.g., pilot signals). For example, the transmit processor 1020 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1044 may be used by a controller/processor 1040 to determine the coding, modulation, spreading, and/or scrambling schemes for the transmit processor 1020. These channel estimates may be derived from a reference signal transmitted by the UE 1050 or from feedback from the UE 1050. The symbols generated by the transmit processor 1020 are provided to a transmit frame processor 1030 to create a frame structure. The transmit frame processor 1030 creates this frame structure by multiplexing the symbols with information from the controller/processor 1040, resulting in a series of frames. The frames are then provided to a transmitter 1032, which provides various signal conditioning functions including amplifying, filtering, and modulating the frames onto a carrier for downlink transmission over the wireless medium through antenna 1034. The antenna 1034 may include one or more antennas, for example, including beam steering bidirectional adaptive antenna arrays or other similar beam technologies.

At the UE 1050, a receiver 1054 receives the downlink transmission through an antenna 1052 and processes the transmission to recover the information modulated onto the carrier. The information recovered by the receiver 1054 is provided to a receive frame processor 1060, which parses each frame, and provides information from the frames to a channel processor 1094 and the data, control, and reference signals to a receive processor 1070. The receive processor 1070 then performs the inverse of the processing performed by the transmit processor 1020 in the Node B 1010. More specifically, the receive processor 1070 descrambles and despreads the symbols, and then determines the most likely signal constellation points transmitted by the Node B 1010 based on the modulation scheme. These soft decisions may be based on channel estimates computed by the channel processor 1094. The soft decisions are then decoded and deinterleaved to recover the data, control, and reference signals. The CRC codes are then checked to determine whether the frames were successfully decoded. The data carried by the successfully decoded frames will then be provided to a data sink 1072, which represents applications running in the UE 1050 and/or various user interfaces (e.g., display). Control signals carried by successfully decoded frames will be provided to a controller/processor 1090. When frames are unsuccessfully decoded by the receiver processor 1070, the controller/processor 1090 may also use an acknowledgement (ACK) and/or negative acknowledgement (NACK) protocol to support retransmission requests for those frames.

In the uplink, data from a data source 1078 and control signals from the controller/processor 1090 are provided to a transmit processor 1080. The data source 1078 may represent applications running in the UE 1050 and various user interfaces (e.g., keyboard). Similar to the functionality described in connection with the downlink transmission by the Node B 1010, the transmit processor 1080 provides various signal processing functions including CRC codes, coding and interleaving to facilitate FEC, mapping to signal constellations, spreading with OVSFs, and scrambling to produce a series of symbols. Channel estimates, derived by the channel processor 1094 from a reference signal transmitted by the Node B 1010 or from feedback contained in the midamble transmitted by the Node B 1010, may be used to select the appropriate coding, modulation, spreading, and/or scrambling schemes. The symbols produced by the transmit processor 1080 will be provided to a transmit frame processor 1082 to create a frame structure. The transmit frame processor 1082 creates this frame structure by multiplexing the symbols with information from the controller/processor 1090, resulting in a series of frames. The frames are then provided to a transmitter 1056, which provides various signal conditioning functions including amplification, filtering, and modulating the frames onto a carrier for uplink transmission over the wireless medium through the antenna 1052.

The uplink transmission is processed at the Node B 1010 in a manner similar to that described in connection with the receiver function at the UE 1050. A receiver 1035 receives the uplink transmission through the antenna 1034 and processes the transmission to recover the information modulated onto the carrier. The information recovered by the receiver 1035 is provided to a receive frame processor 1036, which parses each frame, and provides information from the frames to the channel processor 1044 and the data, control, and reference signals to a receive processor 1038. The receive processor 1038 performs the inverse of the processing performed by the transmit processor 1080 in the UE 1050. The data and control signals carried by the successfully decoded frames may then be provided to a data sink 1039 and the controller/processor, respectively. If some of the frames were unsuccessfully decoded by the receive processor, the controller/processor 1040 may also use an acknowledgement (ACK) and/or negative acknowledgement (NACK) protocol to support retransmission requests for those frames.

The controller/processors 1040 and 1090 may be used to direct the operation at the Node B 1010 and the UE 1050, respectively. For example, the controller/processors 1040 and 1090 may provide various functions including timing, peripheral interfaces, voltage regulation, power management, and other control functions. The computer-readable media of memories 1042 and 1092 may store data and software for the Node B 1010 and the UE 1050, respectively. A scheduler/processor 1046 at the Node B 1010 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” or processor (FIG. 6) that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 606 (FIG. 6). The computer-readable medium 606 (FIG. 6) may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication of a user equipment (UE), comprising:
receiving an indication to perform a call origination procedure when communicating in a serving cell;
selecting a neighbor cell for performing the call origination procedure based at least in part on receiving the indication; and
performing the call origination procedure with a wireless network using the neighbor cell after selecting the neighbor cell in response to receiving the indication.

2. The method of claim 1, wherein selecting the neighbor cell comprises performing reselection from the serving cell to the neighbor cell regardless of whether a reselection timer is expired.

3. The method of claim 1, wherein selecting the neighbor cell comprises switching from a first subscription that uses the serving cell to a second subscription that uses the neighbor cell as a second serving cell.

4. The method of claim 3, further comprising managing, by the UE, the first subscription and the second subscription using respective subscriber identity modules in the UE.

5. The method of claim 1, wherein the indication to perform the call origination procedure comprises a call request processed at the UE.

6. The method of claim 1, wherein the indication to perform the call origination procedure comprises a paging message received from the serving cell.

7. The method of claim 1, wherein performing the call origination procedure comprises at least transmitting an access preamble to the neighbor cell over a common access channel at the neighbor cell.

8. The method of claim 1, further comprising comparing a first signal parameter of the serving cell with a first threshold and a second signal parameter of the neighbor cell with a second threshold, wherein selecting the neighbor cell is based at least in part on determining the first signal parameter is less than the first threshold, and that the second signal parameter achieves or exceeds the second threshold.

9. The method of claim 8, further comprising determining a type of a call related to the call origination procedure, wherein the first threshold or the second threshold is determined based at least in part on the type of the call.

10. The method of claim 8, wherein the first threshold or the second threshold is determined based at least in part on a determined receiver performance at the UE.

11. The method of claim 1, further comprising determining a type of a call related to the call origination procedure, wherein selecting the neighbor cell is based at least in part on the type of the call.

12. An apparatus for wireless communication of a user equipment (UE), comprising:
means for receiving an indication to perform a call origination procedure when communicating in a serving cell; and
means for selecting a neighbor cell for performing the call origination procedure based at least in part on receiving the indication,
wherein the means for receiving is configured for performing the call origination procedure with a wireless network using the neighbor cell after the means for selecting selects the neighbor cell in response to receiving the indication.

13. The apparatus of claim 12, wherein the means for selecting is configured for selecting the neighbor cell at least in part by performing reselection from the serving cell to the neighbor cell regardless of whether a reselection timer is expired or switching from a first subscription that uses the serving cell to a second subscription that uses the neighbor cell as a second serving cell.

14. The apparatus of claim 12, wherein the indication to perform the call origination procedure comprises a call request processed at the UE or a paging message received from the serving cell.

15. The apparatus of claim 12, wherein the means for receiving is configured for performing the call origination procedure at least in part by transmitting an access preamble to the neighbor cell over a common access channel at the neighbor cell.

16. An apparatus for wireless communication of a user equipment (UE), comprising:
a call originating component operable for receiving an indication to perform a call origination procedure when communicating in a serving cell; and
a selection component operable for selecting a neighbor cell for performing the call origination procedure based at least in part on receiving the indication,
wherein the call originating component is further operable for performing the call origination procedure with a wireless network using the neighbor cell after the selection component selects the neighbor cell in response to receiving the indication.

17. The apparatus of claim 16, wherein the selection component is a cell selecting component operable for selecting the neighbor cell at least in part by performing reselection from the serving cell to the neighbor cell regardless of whether a reselection timer is expired.

18. The apparatus of claim 16, wherein the selection component is a multiple subscription managing component operable for selecting the neighbor cell at least in part by switching from a first subscription that uses the serving cell to a second subscription that uses the neighbor cell as a second serving cell.

19. The apparatus of claim 18, wherein the multiple subscription managing component is further operable for managing the first subscription and the second subscription using respective subscriber identity modules.

20. The apparatus of claim 16, wherein the indication to perform the call origination procedure comprises a call request processed at the UE.

21. The apparatus of claim 16, wherein the indication to perform the call origination procedure comprises a paging message received from the serving cell.

22. The apparatus of claim 16, wherein the call originating component is further operable for at least transmitting an access preamble to the neighbor cell over a common access channel at the neighbor cell.

23. The apparatus of claim 16, further comprising a parameter comparing component operable for comparing a first signal parameter of the serving cell with a first threshold and a second signal parameter of the neighbor cell with a second threshold, wherein the selection component is further operable for selecting the neighbor cell based at least in part on determining the first signal parameter is less than the first threshold, and that the second signal parameter achieves or exceeds the second threshold.

24. The apparatus of claim 23, further comprising a call type determining component operable for determining a type of a call related to the call origination procedure, wherein the parameter comparing component determines the first threshold or the second threshold based at least in part on the type of the call.

25. The apparatus of claim 23, wherein the parameter comparing component is further operable to determine a receiver performance at the UE, and wherein the parameter comparing component is operable to determine the first threshold or the second threshold based at least in part on the receiver performance at the UE.

26. The apparatus of claim 16, further comprising a call type determining component operable for determining a type of a call related to the call origination procedure, wherein the selection component is operable for selecting the neighbor cell based at least in part on the type of the call.

27. A non-transitory computer-readable medium, comprising:
code executable by a computer for receiving an indication to perform a call origination procedure when communicating in a serving cell;
code executable by the computer for selecting a neighbor cell for performing the call origination procedure based at least in part on receiving the indication; and
code executable by the computer for performing the call origination procedure with a wireless network using the neighbor cell after selecting the neighbor cell in response to receiving the indication.

28. The computer-readable medium of claim 27, wherein the code executable by the computer for selecting is configured for selecting the neighbor cell at least in part by performing reselection from the serving cell to the neighbor cell regardless of whether a reselection timer is expired, or selecting the neighbor cell at least in part by switching from a first subscription that uses the serving cell to a second subscription that uses the neighbor cell as a second serving cell.

29. The computer-readable medium of claim 27, wherein the indication to perform the call origination procedure comprises a call request processed at a user equipment or a paging message received from the serving cell.

30. The computer-readable medium of claim 27, wherein the code executable by the computer for performing the call origination procedure is configured for at least transmitting an access preamble to the neighbor cell over a common access channel at the neighbor cell.
